(19) United States
(12) Patent Application Publication
(10) Pub. No.: US 2021/0323342 A1
(43) Pub. Date: Oct. 21, 2021

(54) Disposable Writing Utensil Apparatus

(71) Applicant: Philip Scherrer, Ft. Lauderdale, FL (US)

(72) Inventor: Philip Scherrer, Ft. Lauderdale, FL (US)

(21) Appl. No.: 17/235,746

(22) Filed: Apr. 20, 2021

Related U.S. Application Data
(60) Provisional application No. 63/012,604, filed on Apr. 20, 2020.

(51) Int. Cl. B43K 1/01; G06F 3/0354; B43K 29/00

(52) U.S. Cl. CPC B43K 1/01; B43K 29/00; G06F 3/03545

(57) ABSTRACT

The present invention relates to a disposable pen apparatus. Specifically, the disposable pen apparatus comprises a solid base having a limited use ink reservoir and a pen tip on a first end thereof and a stylus tip on a second end thereof for use with an electronic pad. The disposable pen apparatus further comprises a tear-away plastic wrapper for one-time use.

### CROSS-REFERENCE TO RELATED APPLICATIONS

The present invention claims priority to U.S. Provisional Pat. App. No. 63/012,604, titled “Disposable Writing Utensil Apparatus,” filed Apr. 20, 2020, which is incorporated herein by reference in its entirety.

### TECHNICAL FIELD

The present invention relates to a disposable pen apparatus. Specifically, the disposable pen apparatus comprises a solid base having a limited use ink reservoir and a pen tip on a first end thereof and a stylus tip on a second end thereof for use with an electronic pad. The disposable pen apparatus further comprises a tear-away plastic wrapper for one-time use.

### BACKGROUND

The use of writing utensils can spread communicable diseases, such as bacteria, fungi, viruses, and the like. Oftentimes, people handle writing utensils and use the same, and then share the writing utensils with others, leading to the spread of infection.

Oftentimes, individuals must use writing utensils at stores, gas stations, restaurants, banks, or other like locations for signing sales receipts, checks, or other like legal documents. The public use of writing utensils can further the spread of communicable diseases. Standard pens are often used for this purpose, but typically contain an amount of ink that is stored within the entire barrel of the pen, discouraging users from using them merely for a single use. Thus, because pens have enough ink for many multiple uses, the spread of communicable diseases is often encouraged as users tend not to dispose of them until they run out of ink.

Moreover, electronic pads are often used by individuals for electronically signing their names or for making selections on a keypad, such as numbers or other selections on a keypad. For example, credit card transactions are often conducted at a store. The credit card is often swiped or inserted into a chip reader, and selections must be made using a keypad. Processing is often concluded by using a stylus to sign the credit card user's name on an electronic screen. The use of an electronic stylus, especially one for public use, also can spread communicable diseases in the same manner as a writing utensil, such as a pen.

A need, therefore, exists for an improved writing utensil apparatus. Specifically, a need exists for an improved writing utensil apparatus utilized for single-use applications. More specifically, a need exists for an improved writing utensil apparatus that utilizes a relatively small reservoir of ink that is configured to be utilized in a single-use application.

Moreover, a need exists for an improved writing utensil apparatus utilized for single-use electronic keypad applications. Specifically, a need exists for an improved writing utensil apparatus comprising a stylus configured for single use keypad applications. Moreover, a need exists for an improved writing utensil apparatus having a disposable wrap therearound configured for single use.

### SUMMARY OF THE INVENTION

The present invention relates to a disposable pen apparatus. Specifically, the disposable pen apparatus comprises a solid base having a limited use ink reservoir and a pen tip on a first end thereof and a stylus tip on a second end thereof for use with an electronic pad. The disposable pen apparatus further comprises a tear-away plastic wrapper for one-time use.

To this end, in an embodiment of the present invention, a writing utensil apparatus is provided. The writing utensil apparatus comprises a shaft having a writing tip element on a first end thereof and an electronic stylus on a second end thereof, the writing tip comprising an ink reservoir disposed within the writing tip element, and an ink tube configured to deliver ink from the ink reservoir to a tip of the writing tip element for delivery to a writing surface.

It is, therefore, an advantage and objective of the present invention to provide an improved writing utensil apparatus.

Specifically, it is an advantage and objective of the present invention to provide an improved writing utensil apparatus utilized for single-use writing applications.

More specifically, it is an advantage and objective of the present invention to provide an improved writing utensil apparatus that utilizes a relatively small reservoir of ink that is configured to be utilized in a single-use application.

Moreover, is it is an advantage and objective of the present invention to provide an improved writing utensil apparatus utilized for single-use electronic keypad applications.

Specifically, it is an advantage and objective of the present invention to provide an improved writing utensil apparatus comprising a stylus configured for single use keypad applications.

Moreover, it is an advantage and objective of the present invention to provide an improved writing utensil apparatus having a disposable wrap therearound configured for single use.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a side view of a writing utensil apparatus in an embodiment of the present invention.

FIG. 1A illustrates a close-up view of a tip of a writing utensil apparatus in an embodiment of the present invention.

FIG. 2 illustrates a writing utensil apparatus in a disposable wrapper in an embodiment of the present invention.

### DETAILED DESCRIPTION OF THE PRESENTLY PREFERRED EMBODIMENTS

The present invention relates to a disposable pen apparatus. Specifically, the disposable pen apparatus comprises a solid base having a limited use ink reservoir and a pen tip on a first end thereof and a stylus tip on a second end thereof for use with an electronic pad. The disposable pen apparatus further comprises a tear-away plastic wrapper for one-time use.

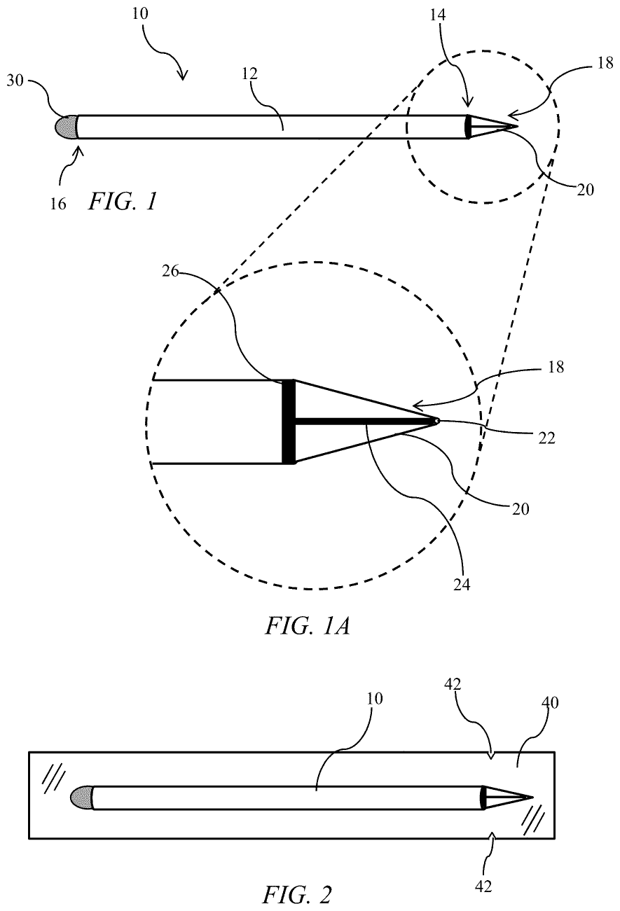

Now referring to the drawings, FIG. 1 illustrates a writing utensil apparatus 10 in an embodiment of the present invention. The writing utensil apparatus 10 comprises a shaft 12 having a first end 14 and a second end 16. The first end 14 of the shaft 12 may comprise a writing utensil tip 18, generally comprising a conical tip element 20. The shaft 12 may preferably be solid, or may be hollow, as desired by one of ordinary skill in the art, and may preferably be made from recycled and/or recyclable materials, such as plastic, wood, wood pulp, metal, or other like materials.

The conical tip element 20, as illustrated in close-up view in FIG. 1A, may comprise a standard ball-point tip element 22 that may be utilized to write ink using ink contained therein. Specifically, the ink may be utilized via an ink tube 24 extending from an ink reservoir 26 disposed generally in or adjacent to the conical tip element 20. The ink reservoir 26 may contain an amount of ink therein, generally enough ink for a single-use application. The ink reservoir 26 may deliver the ink through the ink tube 24 to the ball-point tip element 22 for use thereof by an individual. The ink reservoir 26 may be any volume required to produce sufficient ink for a single use application. Indeed, the ink reservoir 26 may simply be a short tube containing ink and interconnected with the tip and the ball-point tip element 22. It should be noted that although the apparatus is described herein with a ball-point tip element 22, any other pen element may be incorporated herein, as a replacement to the ball-point tip element 22 or in addition thereto, for dispensing ink therefrom as needed, and the present invention should not be limited as described herein.

On a second end 16 of the shaft 12 may be a stylus element 30 that may be utilized for using the apparatus 10 with an electronic keypad, such as for selecting buttons or the like, or for writing on electronic pads, such as signatures or the like. The stylus may have a rounded shape, as shown in FIG. 1, or may have a point thereon, and may be made from a material that easily interacts with electronic keypads and signature pads, such as with resistive or capacitive touchpads.

As illustrated in FIG. 2, the writing utensil apparatus 10 may be contained within a hermetic wrapper 40 so that the writing utensil apparatus 10 may maintain sterility prior to use thereof. The hermetic wrapper 40 may be sealed therearound, and may further have notches 42 that may allow a user to grip and tear away a portion of the wrapper 40 to gain access to the writing utensil 10. Of course, any means of obtaining the writing utensil 10 from within the wrapper 40 may be utilized, and the present invention should not be limited as described herein.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

I claim:

1. A writing utensil apparatus comprising:
a shaft having a writing tip element on a first end thereof and an electronic stylus on a second end thereof, the writing tip comprising an ink reservoir disposed only within the writing tip element, and an ink tube configured to deliver ink from the ink reservoir to a tip of the writing tip element for delivery to a writing surface.
